(19) United States
(12) Patent Application Publication
(10) Pub. No.: US 2003/0222890 A1
(43) Pub. Date: Dec. 4, 2003

(54) System and method for adaptable presentations

(76) Inventors: David Salesin, Seattle, WA (US); Tomer Moscovich, Tenafly, NJ (US)

Correspondence Address: LYON & HARR, LLP, 300 ESPLANADE DRIVE, SUITE 800, OXNARD, CA, 93036, US

(21) Appl. No.: 10/159,640

(22) Filed: May 31, 2002

(51) Int. Cl. G09G 5/00

(52) U.S. Cl. 345/629

(57) ABSTRACT

A system and method for authoring and navigating electronic presentations. This adaptable presentation system and method allows multiple versions of slides and multiple pathways through them, providing much greater flexibility at the time of the presentation without adding too much cognitive load on the part of the presenter. Associated with this system and method are specialized authoring and navigation user interfaces that simplify the authoring and presentation tasks.

### BACKGROUND

1. Technical Field

This invention is directed toward a system and process for creating and presenting adaptable electronic presentations. More particularly, this invention is directed toward a system and process for creating multiple versions of portions of an electronic presentation and allowing a presenter to select the desired portions while giving the presentation.

2. Background Art

Electronic presentations are typically made up of several electronic “slides” that are similar to the slides presented in a non-electronic presentation. For example, these electronic slides employ the use of bullets or text paragraphs and graphics such as charts. However, electronic presentations also have a multitude of other features such as animation, graphical effects and automatic presentation timing that enhance the presentation experience for both the presenter and the audience.

According to estimates, at least thirty million electronic presentations are made everyday. Even if this statistic is a gross overestimation, the implication is clear: presentation software is one technology that is having an impact on people's lives. However, despite its popularity, modern-day presentation software is still firmly rooted in the past. Initial versions of electronic presentation software were released in the 1980s. This software was originally designed to create black-and-white text and graphics pages for photocopying onto overhead transparencies, which would later be shown to an audience using an overhead projector. In such a setting, the presentations were necessarily fixed and immutable in nature (other than the ability to shuffle slides, which arguably was easier at that time with the physical objects in hand).

Although the software has since evolved in many ways, electronic presentations are still essentially static in nature. Current-day presentation software like Microsoft Corporation's PowerPoint® presentation software supports only one, fixed version of any given slide, and only one, inflexible presentation order for the “slide deck” as a whole. This fixed structure disregards the way that talks are typically created, edited, and presented. For instance, it is common to create multiple versions of a talk, intended for different situations or audiences (say, a twenty-minute presentation versus a one-hour colloquium versus a five-minute summary). Today, presenters typically create each new version by making a copy of the slide set and editing it for the new situation. As these changed copies multiply and diverge, it becomes difficult to keep all the versions coherent as edits are propagated back and forth (or not). Different documents also make it difficult to smoothly transition between slides from multiple versions while onstage, in response to, say, a question from the audience. Many presenters will prepare “back up” copies of slides for anticipated questions from the audience that may be difficult to locate when several sets of backup copies are prepared.

The canonical software package for producing presentations is Microsoft Corporation's PowerPoint® presentation software, which began as a tool for creating offline presentation documents. Other tools, such as web-browsers and Pad [2] and its derivatives, have also gained some currency as presentation tools. However, these tools lack some of the important features of specialized presentation software (e.g., graphical rearrangement of slides, and easy navigation through presentations). While tools for creating and navigating nonlinear documents have been around for decades (indeed, web-browsers have become ubiquitous) few have focused on the specific demands of giving presentations. The document presentation system of Feiner et al. [1] provided for the creation of hierarchical hyperlinked documents. The system was used for maintenance and repair manuals, and could be used to give presentations, but without customizable paths the speaker was forced to invent the presentation sequence on the fly.

It is noted that in the preceding paragraphs, as well as in the remainder of this specification, the description refers to various individual publications identified by a numeric designator contained within a pair of brackets. For example, such a reference may be identified by reciting, “reference [1]” or simply “[1]”. A listing of the publications corresponding to each designator can be found at the end of the Detailed Description section.

### SUMMARY

The adaptable presentation system and process overcomes the aforementioned limitations in systems for creating and delivering electronic presentations. The adaptable presentation system enables the creation of better presentations, by taking full advantage of the opportunities afforded by real-time rendering and projection—dynamically choosing in which direction the talk will go while it is being given.

The adaptable presentation system represents multiple versions of an electronic presentation as a single document. The presenter is allowed more flexibility and control at runtime by representing all versions of a talk as multiple paths through a single pool of visual material.

The adaptable presentation system and process for creating and presenting an electronic presentation operates as follows. A set of typical electronic slides containing the contents of a presentation (e.g., text, graphics, animation objects or scenes, audio, video and so on) are input into the system. The slides can be created using any conventional presentation software. Various versions of a particular slide can be created to address factors such as different level of detail, audience type or timing constraints.

The input set of slides is then grouped into one or more subgroups of slides. For example the slides may be grouped by using criteria like the aforementioned subject matter or audience type. Section or group paths are then created for each group of slides. Each section or group path represents the order in which each slide in the subgroup is to be presented. A particular slide may be on more than one path. Additionally, if the presentation is lengthy or more complex, for example, there may be more than one subgroup of slides. In this case, a number of subgroup paths representing the order in which each subgroup is presented may also be created. When the user presents the slides, he or she selects at least one section path of the possible paths.

The adaptable presentation system and process includes two graphical user interfaces—one for authoring the presentation and one for navigating through and selecting between the various paths of slides in real-time during the presentation. Whereas the authoring view shows a complete structural model of all versions of the presentation, the navigation view focuses attention on a currently active version. Its functions are to help the speaker plan a specific version of the presentation, to track his or her place while delivering the presentation, and to let the speaker improvise changes during the presentation.

The graphic user interface for authoring an electronic presentation includes a user interface for specifying a default sequence of slides and at least one alternative sequence of slides. The authoring graphic user interface depicts a graphical representation or “thumbnail” of each slide. The user can group slides on the display by moving the “thumbnails” of the slides to be grouped in close proximity to each other with an input device. The user then draws a box around the thumbnails of the slides to create the desired group. In one embodiment, the color inside the box changes to more clearly indicate to the user that the associated slides are a group. Boxes for different groups can be assigned different colors by the adaptable presentation system to more clearly indicate to the user that the boxes represent different groups. Additionally, the user may enter an identifier for a set of grouped slides that is displayed on a tab or other indicator associated with the box to identify the group to the user.

The user specifies a sequence order of slides within a group, or between groups by drawing a curve through the slides in order in which they are to be presented. Multiple paths can be created by drawing multiple curves through the thumbnails of slides to define a default sequence order and alternative sequence orders of slides. A given slide can be on more than one path. In one embodiment, a path indicator is associated with each sequence order of slides within a group. The sequence order of slides within a group is highlighted on the display when a user places an input device over this path indicator. The default path defining the sequence order of slides is represented by a heavy line between the slides, and each alternative sequence order is represented by a thinner line than that representing the default sequence order.

The navigation view and user interface for presenting the electronic presentation allow the user to select between a default sequence of slides or one or more alternative sequences. Similar to the authoring view, each slide in the default and alternative presentation sequences is depicted on the display as a thumbnail representation. This default sequence of slides is displayed as thumbnails of each slide in the sequence aligned in a column from top to bottom. The default sequence of the slides may also be highlighted, with any alternative slide sequences being displayed to the sides of the column of the thumbnail slides representing the default sequence. The thumbnail slides of the alternative sequences may also be displayed more dimly than the default slide sequence on the display to further focus the presenter's attention on the active default column.

Similar to the view shown in the authoring view, slides are depicted in groups with a box around them in the navigation view. In one embodiment each box depicting a different group is filled with a different color to more easily indicate to the user that the slides belong to a separate group. The thumbnails of the slides as well as any boxes representing a group of slides are linked by flow lines that represent each sequence of slides.

In one embodiment of the navigation view an indicator is associated with each flow line. When the user places a mouse cursor or other input device over the indicator (e.g., “mouses over” the indicator) associated with a flow line, the thumbnails associated with that sequence of slides are highlighted on the display. When the user selects the indicator, the slides associated with that indicator are selected as the default path. When this occurs the thumbnails of the slides and the flow lines associated therewith are moved to a central column on the display and are highlighted. Flow lines that intersect a slide that is actively being presented are depicted in a different color from the other flow lines.

In an alternate embodiment of the navigation view, sections are “collapsed” and represented as thumbnail views. Sections can be collapsed either automatically by the system or by the user. For example, in one embodiment a user double-clicks on the section header with a mouse cursor or other input device to collapse or expand the section. This feature is especially useful when a presentation is complex and has many sections. By allowing the sections or groups of slides to be collapsed and shown as thumbnails, more information can be visually displayed to the user. This aids in simplifying the complexity of a lengthy presentation with multiple alternative paths available to the user.

In another alternate embodiment of the adaptable presentation system, each time a presentation is given, the system compiles an estimate of how long the speaker spends on each slide. This allows the system to predict how long each alternative path may take, and this information is displayed to the user. Thus, the speaker is aided in making better-informed decisions about improvising during the presentation. The speaker may also choose to limit the displayed paths to those that fit the remaining time allotted for the presentation. Alternately, as an option, the system can display only those paths that can be completed in the remaining time.

In yet another embodiment, the display can be adapted to different display devices, from room-sized projections to handheld computers. This adaptation affects not only the layout of individual slides, but possibly the organization of an entire talk. On a small device, for instance, it may be better to make a series of talking points with each on its own slide, rather than as a single bulleted list. A long presentation can be shortened by summarizing and skipping sections. For example, during the creation of the presentation, two alternative paths can be created: one that is the summary version of the talk, and the other is the full version. The two versions might use entirely different slides, or one version might be a subset of the other, or the two might have some different slides and some slides in common.

The adaptable presentation system and process has many advantages. For example, an adaptable presentation allows the speaker to seamlessly shift to a more appropriate version of the presentation or to enhance its contents to suit the audience. Additionally, the speaker's navigation view, which is rendered on a different display from the view of the presentation shown the audience, allows for many ways of improving the presentation experience. For example, each time a presentation is given, the system can compile an estimate of how long the speaker spends on each slide. This allows the system to provide a good prediction of how long each alternative path may take, helping the speaker make better-informed decisions about improvising during the presentation. As a result the speaker may then choose to limit the displayed paths to those that fit the allotted time. Streamlining the navigation view, and allowing the speaker to collapse irrelevant sections leaves more space for animation controls, extensive notes, or a large slide preview. Additionally, bulleted lists on slides are frequently used for the benefit of the speaker as much as the audience. By showing speaker notes associated with the bulleted lists in a separate, private display instead of putting them on the slide, screen area is freed up for illustrations or animations.

### DESCRIPTION OF THE DRAWINGS

The specific features, aspects, and advantages of the present invention will become better understood with regard to the following description, appended claims, and accompanying drawings where:

FIG. 1 is a diagram depicting a general purpose computing device constituting an exemplary system for implementing the invention.

FIG. 2 is a flow diagram showing the process actions of creating an adaptable presentation.

FIG. 3 depicts an exemplary User Interface wherein an electronic presentation is turned into an adaptable presentation.

FIGS. 4(a), (b), (c), (d), (e), (f) and (g) depict a series of images of an exemplary User Interface used for arranging a sequence of animated slides into a small multi-path presentation.

FIG. 5 is a flow diagram showing the process actions of presenting an adaptable presentation that has been created previously.

FIGS. 6(a), (b), (c) and (d) depict a series of images of an exemplary User Interface, the navigation view, for the presentation of FIG. 4(a).

### DETAILED DESCRIPTION OF THE PREFERRED EMBODIMENTS

In the following description of the preferred embodiments of the present invention, reference is made to the accompanying drawings that form a part hereof, and in which is shown by way of illustration specific embodiments in which the invention may be practiced. It is understood that other embodiments may be utilized and structural changes may be made without departing from the scope of the present invention.

1.0 Exemplary Operating Environment

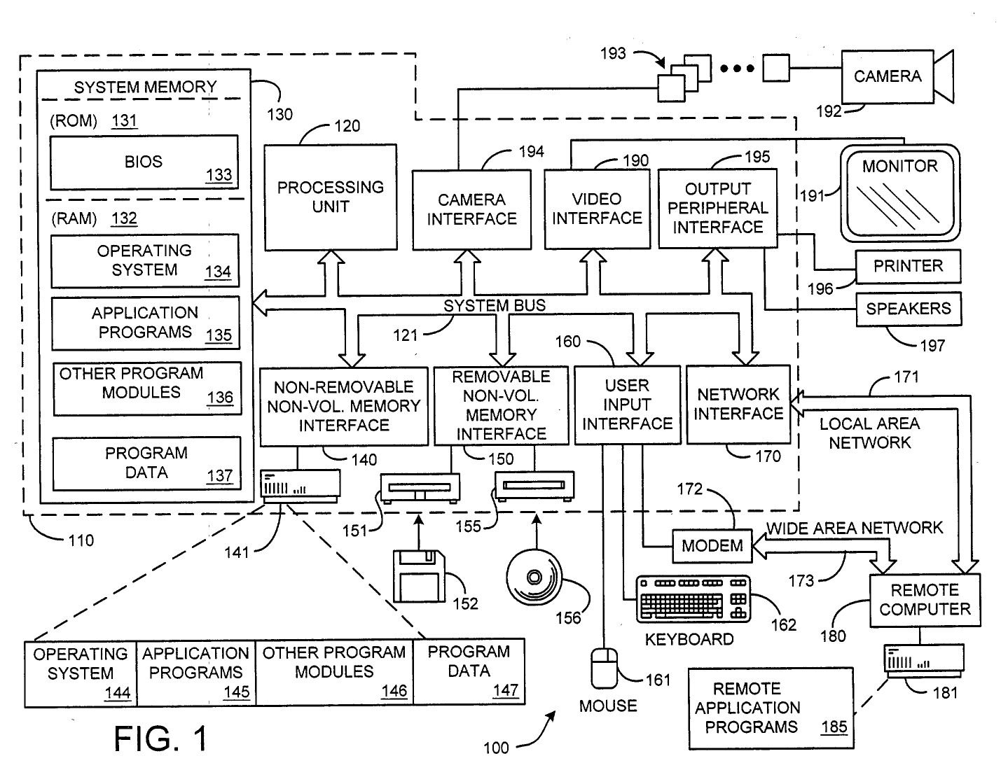

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data'signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195. Of particular significance to the present invention, a camera 163 (such as a digital/electronic still or video camera, or film/photographic scanner) capable of capturing a sequence of images 164 can also be included as an input device to the personal computer 110. Further, while just one camera is depicted, multiple cameras could be included as an input device to the personal computer 110. The images 164 from the one or more cameras are input into the computer 110 via an appropriate camera interface 165. This interface 165 is connected to the system bus 121, thereby allowing the images to be routed to and stored in the RAM 132, or one of the other data storage devices associated with the computer 110. However, it is noted that image data can be input into the computer 110 from any of the aforementioned computer-readable media as well, without requiring the use of the camera 163.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

The exemplary operating environment having now been discussed, the remaining parts of this description section will be devoted to a description of the program modules embodying the invention.

2.0 Adaptable Presentation System and Method.

In this section, the adaptable presentation system and method for creating and delivering adaptable presentations is described.

2.1 Overview

Just as a speaker first designs and then presents a talk, the author of an adaptable presentation first designs the adaptability and then uses that designed-in adaptability during the presentation. In preparing a new talk, or preparing an old talk for the new audience, an author will customize the talk for the expected audience and situation. During the presentation, the speaker may need to adapt the talk to exigencies that arise, such as detailed questions, shortened presentation times, and so on. These two tasks of designing and presenting a presentation are quite different, and in one embodiment of the adaptive presentation there are two user interface views of a presentation system reflecting this. These views are the authoring view and the navigation view. Although these two user interface views are separate in the preferred embodiment, the relevant features of both can be combined into one display.

The authoring and navigation views are designed with several desiderata in mind. First, the simplest adaptable presentation should require no more effort to produce than a linear presentation. That is, the degenerate case of an adaptable presentation should simply be a linear one. Presenters should be able to add aspects and adaptability to their presentations gradually, each time they prepare to give the talk to a new audience. Second, an adaptable presentation should require no more effort to give than a linear one. If things go exactly as expected, the speaker should give the presentation software no instructions other than “advance to the next slide.” But often presentations require some clever improvisation as they are given; with current tools, such events are usually dealt with by rapid-fire clicking of the “next” button to skip over sections of the presentation, or by a hand-waving discussion of the topics for which visuals are inaccessible. An adaptable presentation, on the other hand, allows the speaker to seamlessly shift to a more appropriate version of the presentation or to enhance its contents to suit the audience.

2.2 Structuring an Adaptable Presentation

2.2.1. Background

There are many possible ways to structure an adaptable presentation from a collection of slides. The simplest is to give the speaker random access to all the slides. At presentation time, though, the demands of ordering the talk on the fly present a substantial cognitive load, distracting the speaker with the decision of where to go next after each slide. This approach also ignores any logical structure the content may suggest, such as natural sequences of related slides. Another possibility, one that may be implemented with current technology, is to create hyperlinks between slides, structuring the presentation as a directed graph. This approach lets the speaker build in some sequencing and dependency during authoring, while providing substantial flexibility at presentation time. However, it still requires the speaker to make a choice at each branch point, and as the presentation becomes more complex the demands on the speaker increase.

Ideally, one wants to create a structure that allows the speaker to plan out the order of the talk before it is presented, and also to organize and order alternatives.

2.2.2. Structuring the Adaptable Presentation With an Authoring Tool.

The authoring tool of the adaptable presentation system allows the user to plan a default order of slides to be presented, as well as allowing ordered alternatives to be created. The adaptable presentation system accomplishes this through the use of hierarchy and predefined paths. Just as an author might structure a book into chapters and sections, presentations are allowed to be structured into nested sections. Within each section, the speaker defines one or more section paths—sequences of slides and subsections that make sense—represented as paths through a directed graph. Unlike hyperlinks, multiple paths intersecting on the same slide each have a predetermined way of leaving that slide, so as long as the speaker chooses to remain on a path, he or she need not make a decision at branch points. However, should the speaker wish to change paths, an intersection of two paths is an ideal place to seamlessly do so.

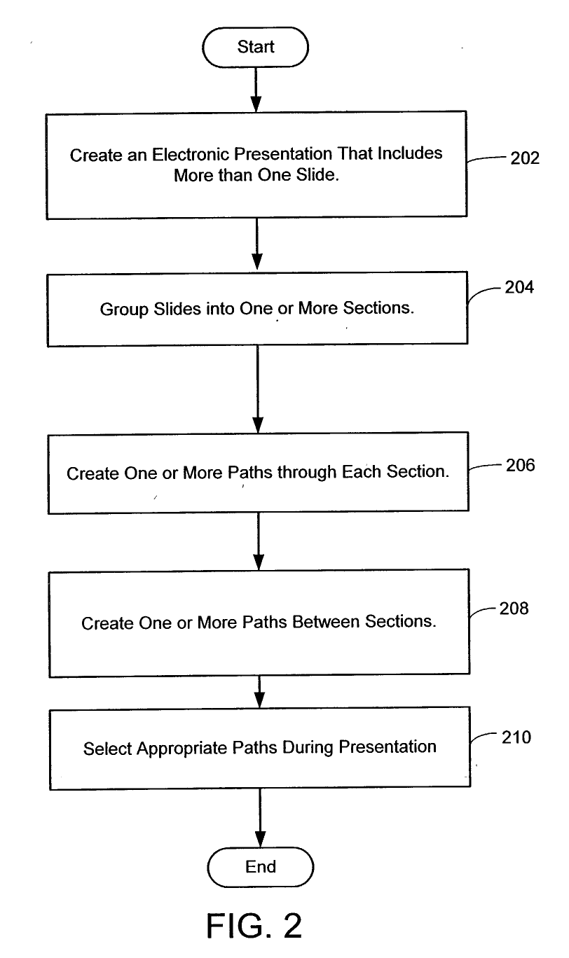

The key authoring tasks the adaptable presentation system supports are creating sections and creating paths through each section and between sections. FIG. 2 depicts a flow diagram of the general process actions of creating an adaptable presentation. Initially, slides of an electronic presentation are created, as shown in process action 202. The slide contents can be assembled in any conventional electronic presentation software. Multiple versions of a particular slide can be created. The slides are then grouped into one or more sections (process action 204). A given slide of a set of slides can be grouped into one or more sections if desired. Grouping of slides is typically done by categorizing slides by a particular subject matter or by selecting slides suitable for a particular audience or time constraints.

Once the slides are grouped into sections, one or more paths are created though each section of slides, as shown in process action 206. The paths depict the sequence in which the slides in a particular section are presented. A given path can be terminated by returning to a particular point on the originating slide, but this is not necessarily so. The path can instead proceed through a completely different sequence. Once the paths for a given section of slides has been created, it is also possible, if desired, to create paths between the various sections (process action 208). At presentation time, the user selects the appropriate paths while giving the talk, thereby tailoring the presentation in real-time for a particular subject, audience or time constraint, as shown in process action 210.

In an alternate embodiment of the adaptive presentation system and method, different attributes can be assigned to different paths. For instance, attributes can indicate whether a particular path is technical or non-technical, whether it is geared to a particular type of audience, or whether the path requires a long or short time frame to present. These kinds of attributes can then later be displayed in the navigation view and used by the presenter in the navigation view as an aid in determining which alternate path to chose in a given presentation environment. Alternately, the adaptive presentation system can use this attributes to automatically create alternative presentation paths.

2.2.3 Authoring View and User Interface.

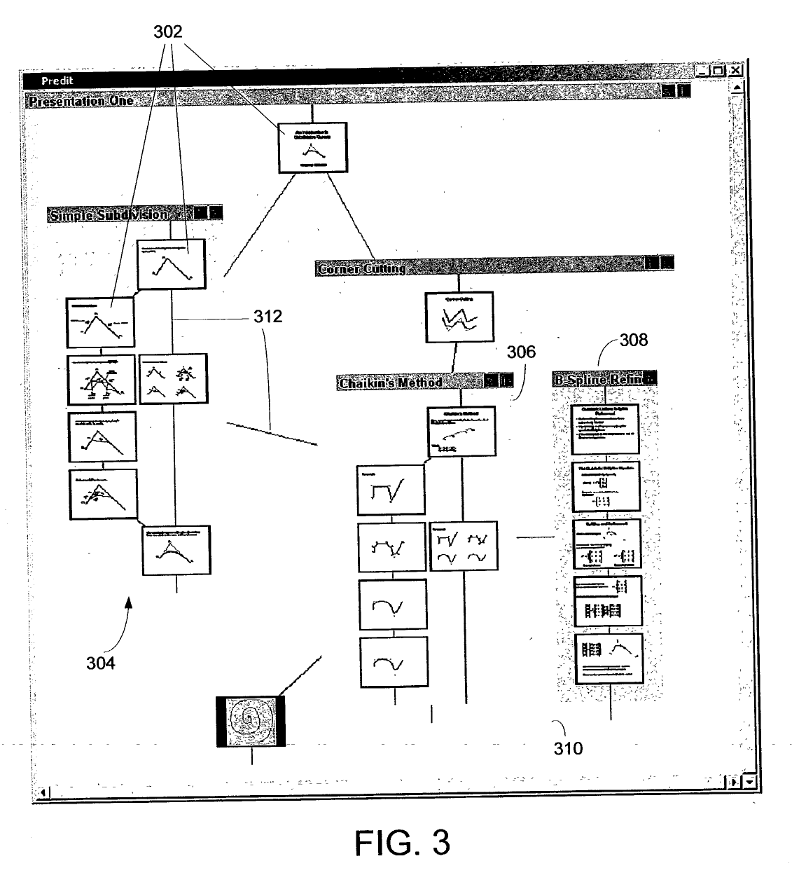

FIG. 3 shows the authoring tool, which has been used to impose a complex structure onto a set of electronic slides 302a, 302b, 302c, 302n about subdivision curves, creating an adaptable talk. Each box 304, 306, 308, 310 represents a section of the presentation. The system assigns a color to each section that is later mirrored in the navigation view in order to provide a mnemonic cue associated with that section. Here, the sections serve to organize the talk by topic into two schemes of subdivision, and to segregate the more technical information. Thin lines 312, here shown in gray, indicate the possible paths through each section. The paths defined in FIG. 3 allow the speaker to take either long or short routes through the various sections, as well as decide whether to cover the more technical aspects of the talk.

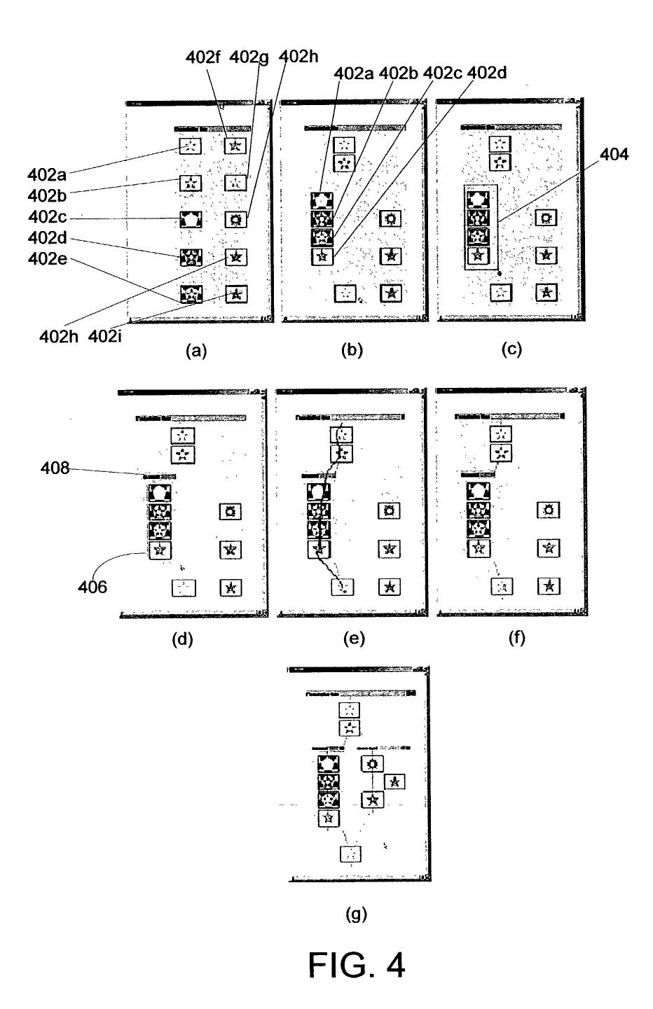

FIGS. 4(a) through 4(g) show how a user creates a presentation in the authoring system. He or she begins by roughly rearranging or grouping the slides (each of which is preferably represented by a thumbnail or graphical representation of the slide), preferably by clicking and dragging them with a mouse or other pointing device. FIG. 4(a) represents the slides 402a, 402b, 402c, 402d, 402e, 402f, 402g, 402h, 402i, 402j of the original electronic presentation shown in thumbnail format. In FIG. 4(b) the user roughly groups certain sets of slides (e.g., 402c, 402d, 402e, 402f) by co-locating them. Then, to define a section, as shown in FIG. 4(c), the user draws a box 404 surrounding the group of slides, preferably by shift-dragging a box around the thumbnail depictions of the slides to be grouped into the section. The surrounded items form a new section 406, as shown in FIG. 4(d). This section can be identified with a heading tab 408, which contains an identifier for the particular section. The box surrounding the section 406, is also depicted in a different color to visually indicate that the slides contained therein represent a separate section or group. The user creates a path by using a mouse or other input device to sketch a curve 410 through a sequence of slides in a given section, as shown in FIG. 4(e). In one embodiment of the system, shown in FIG. 4(f), the initial letter of each path's name is displayed in a tab on that section's title-bar. Holding the mouse over one of these tabs highlights the corresponding path. The completed presentation can be seen in FIG. 4(g).

2.3 The Navigation View

Once the adaptable presentation is created in the authoring view, the presenter uses the navigation view to present it.

2.3.1. Background

Ideally, navigating an adaptable presentation should be as simple as traversing a traditional one. However, the greater complexity of the adaptable presentation structure demands some tool that lets the speaker visualize and control the talk structure. Even presenters of traditional talks often complain that they have difficulty remembering what slide comes next. Moreover, the large number of possible choices and actions require more interface than a “next” and “previous” button that are typically used to navigate in many electronic presentation software applications.

2.3.2. Navigation View.

To address problems of complexity and facilitate ease of use, a navigation view is provided in the adaptable presentation system and method. This navigation view provides a “big-picture” view of the presentation structure, that is preferably rendered on a separate display from the presentation itself. To provide the navigation view, the adaptable presentation system and method therefore preferably employs the use of a computer that supports multiple monitors or displays. Such capability is provided using conventional techniques such as desktop or laptop computers having two video cards or a single multi-head video card. With this multiple monitor feature enabled, the user launches the presentation or slide show. The navigation view is then displayed on the presenter's screen, while the slide show is presented normally to the audience on at least one additional monitor. Dual-headed graphics cards are widely available, even on notebook computers, so this is a feasible approach.

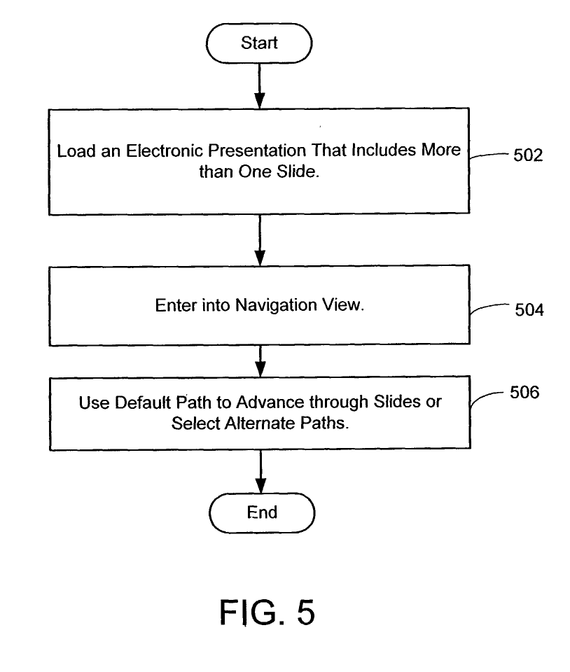

When giving an electronic presentation, the speaker simply loads the presentation in the navigation view and user interface of the adaptable presentation system (process action 502), as shown in FIG. 5, which in turn launches the electronic presentation software, such as, for example, Microsoft's PowerPoint® electronic presentation software, bringing up the navigation view as shown in process action 504. The adaptable presentation system controls the electronic software application, telling it which slide to display via the Windows COM mechanism. COM is a standardized interface for applications to communicate with one another. Basically, the adaptable presentation system sends a message to the presentation software telling it which slide to display. The presenter can advance through the talk along the active default path in the usual fashion (e.g., by pressing the space bar), or can shift to an alternative path (e.g., with a few clicks of the mouse), as shown in process action 506.

Whereas the authoring view shows a complete structural model of all versions of the presentation, the navigation view focuses attention on a currently active version. Its functions are to help the speaker plan a specific version of the presentation, to track his or her place while delivering the presentation, and to let the speaker improvise changes during the presentation.

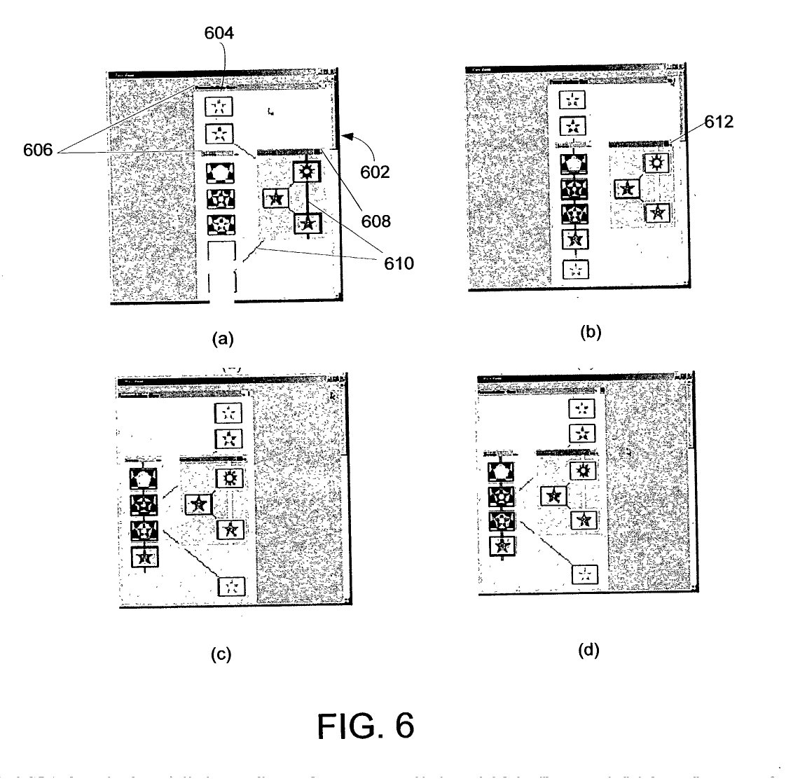

The navigation view 602, shown in FIGS. 6(a), (b), (c) (d), arranges the active sequence of slides in relation to other possible sequences. The active sequence of slides is highlighted and aligned in a central column 604 from top to bottom, so the speaker can scan down the active column to preview the slide show. The active column 604 represents the set of slides that the speaker would present if he or she did not deviate from the default path of slides. Pressing the space bar or down-arrow will advance along this path. The titles of the other paths through the section are indicated by tabs 606 at the upper-right of each section. Paths that intersect the current slide have their title tab 606 highlighted in pink. Inactive alternative sequences 608 are shown, dimmed, to the sides of the active column. To suggest the topology of the presentation with minimal visual complexity, slides and sections are linked by flow lines 610 that represent the union of the possible paths. Thus, paths that share some sequence of slides are depicted by a single flow line 610.

To distinguish and select among available paths within a section, path tabs 612 are used at the top of each box. Path tabs 612 corresponding to each path through the section are shown in the right corner of the section's title bar. When the speaker “mouses over” a path tab, the corresponding path is highlighted in white and the rest of the presentation is dimmed (FIG. 6(b)). By clicking a tab 612, the user selects a new path; the display rearranges to show the new active path down the center column as shown in FIG. 6(c). The space bar will now advance the presentation along the new path as shown in FIG. 6(d). Speakers may use the aforementioned tabs to rapidly explore presentation possibilities and to control the presentation by changing paths.

In an alternate embodiment of the adaptable presentation system and method, sections are “collapsed” and represented as thumbnail views. This feature is especially useful when a presentation is complex and has many sections. By allowing the sections to be collapsed and shown as thumbnails, more information can be visually displayed to the user. This aids in simplifying the complexity of a lengthy presentation with multiple alternative paths available to the user.

In another alternate embodiment, each time a presentation is given, the system compiles an estimate of how long the speaker spends on each slide. This allows the system to predict how long each alternative path may take, and this information is displayed to the user. Thus, the speaker is aided in making better-informed decisions about improvising during the presentation. The speaker may also choose to limit the displayed paths to those that fit the remaining time allotted for the presentation. Alternately, as an option, the system can display only those paths that can be completed in the remaining time.

In yet another embodiment, the display can be adapted to different display devices, from room-sized projections to handheld computers. This adaptation affects not only the layout of individual slides, but possibly the organization of an entire talk. On a small device, for instance, it may be better to make a series of talking points with each on its own slide, rather than as a single bulleted list. A long presentation that can be shortened by summarizing and skipping sections. For example, during the creation of the presentation, two alternative paths can be created: one that is the summary version of the talk, and the other is the full version. The two versions might use entirely different slides, or one version might be a subset of the other, or the two might have some different slides and some slides in common.

The speaker's navigation view allows for many ways of improving the presentation experience. For example, each time a presentation is given, the system can compile an estimate of how long the speaker spends on each slide. This allows the system to provide a good prediction of how long each alternative path may take. This helps the speaker make better-informed decisions about improvising during the presentation. The speaker may then choose to limit the displayed paths to those that fit the allotted time. Streamlining the navigation view, and allowing the speaker to collapse irrelevant sections leaves more space for animation controls, extensive notes, or a large slide preview. Additionally, bulleted lists on slides are frequently used for the benefit of the speaker as much as the audience. By showing speaker notes associated with the bulleted lists in a separate, private display instead of putting them on the slide, screen area is freed up for illustrations or animations.

The foregoing description of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

References

[1] S. Feiner, S. Nagy, and A. van Dam. An integrated system for creating and presenting complex computer-based documents. In Henry Fuchs, editor, Computer Graphics (Proceedings of SIGGRAPH 81), volume 15, pages 181-189, August 1981.

[2] Ken Perlin and David Fox. Pad: An alternative approach to the computer interface. In Proceedings of SIGGRAPH 93, 1993.

Wherefore, what is claimed is:

1. A computer-implemented process for presenting an electronic presentation, comprising using a computer to perform the following process actions:
inputting a set of slides, said slides representing the contents of a presentation;
grouping said set of slides into one or more subgroups of slides; and
creating a plurality of section paths for each subgroup, wherein each section path represents the order in which each slide in the subgroup is presented.

2. The computer-implemented process of claim 1 wherein said slide contents comprises at least one of:
text;
graphics;
animation effects;
video; and
audio.

3. The computer-implemented process of claim 1 further comprising the process action of:
selecting at least one section path when presenting said slides.

4. The computer-implemented process of claim 1 further comprising the process actions of:
creating at least one subgroup path representing the order in which each subgroup is presented; and
selecting at least one subgroup path when presenting said slides.

5. The computer-implemented process of claim 1 wherein a slide is on the section path of more than one subgroup.

6. The computer-implemented process of claim 4 wherein a slide is on the subgroup path of more than one subgroup.

7. The computer-implemented process of claim 1 wherein a slide is grouped into a subgroup based on similar slide content.

8. A system for creating an electronic presentation, the system comprising:
a general purpose computing device; and
a computer program comprising program modules executable by the computing device, wherein the computing device is directed by the program modules of the computer program to,
input an electronic presentation whose contents is captured in electronic slides,
group slides into sections,
create one or more ordered intra-section sequences, each ordered intra-section sequence depicting an order in which the slides in the section may be presented; and
create one or more ordered inter-section sequences depicting an order in which sections may be presented.

9. The system of claim 8, further comprising a program module to:
select from one or more ordered intra-section sequences or intersection sequences while giving the electronic presentation.

10. A graphic user interface for authoring an electronic presentation viewed on a display device, comprising a user interface for specifying a default sequence of slides containing presentation content and at least one alternative sequence of slides containing presentation content.

11. The graphic user interface of claim 9 wherein the user interface for the specifying default slide sequence and the at least one alternative slide sequence further comprises a graphical representation of each slide on a display device.

12. The graphic user interface of claim 11 wherein a user can group slides on said display device by:
moving the graphical representations of said slides to be grouped in close proximity to each other with an input device; and
drawing a box around said graphical representations of said slides in close proximity with each other to create a group.

13. The graphic user interface of claim 12 wherein the color inside the box around the slides in close proximity to each other changes color to more clearly indicate to the user that the slides are a group.

14. The graphic user interface of claim 12 wherein the color inside a box around said graphical representations of said slides in close proximity with each other is a different color from another box around other said graphical representations of said slides in close proximity with each other to indicate to the user that the boxes represent different groups.

15. The graphic user interface of claim 12 wherein a user can enter an identifier for a set of grouped slides that is displayed on an indicator associated with the box to identify the group to the user.

16. The graphic user interface of claim 12 wherein a user can specify a sequence order of slides within a group by drawing a curve through said slides in order of how they will be presented.

17. The graphic user interface of claim 16 wherein the sequence order of slides is depicted by line between the graphical representations of said slides connecting the slides in the order in which they are to be presented.

17. The graphic user interface of claim 15 wherein a path indicator is associated with each sequence order of slides within a group.

18. The graphic user interface of claim 17 wherein the sequence order of slides within a group is highlighted on the display when a user places an input device over the path indicator.

19. The graphic user interface of claim 16 wherein multiple curves are drawn through the graphical representations of slides to define a default sequence order and alternative sequence order of slides within the group.

20. The graphic user interface of claim 12 wherein a user can specify a sequence order of groups of slides by drawing a curve between said boxes representing a group in order of how they will be presented.

21. The graphic user interface of claim 10 wherein a user can group slides on said display device by:
assigning an attribute to each slide indicating its type; and
grouping each slide using its indicator.

22. A graphic user interface for presenting an electronic presentation viewed on a display device, comprising a user interface for selecting between a default sequence of slides containing presentation content and at least one alternative sequence of slides containing presentation content.

23. The graphic user interface of claim 22 wherein the user interface for the specifying default slide sequence and the at least one alternative slide sequence further comprises a graphical representation of each slide.

24. The graphic user interface of claim 23 wherein the graphical representations of slides are grouped into sections, each section being shown as a box around the graphical representations of slides that belong to a group.

25. The graphic user interface of claim 24 wherein each box depicting a group is a filled with a different color to indicate a different group.

26. The graphic user interface of claim 24 wherein slides are grouped by at least one of:
like subject matter of slide presentation content;
predicted timing of each slide; and
suitable audience for each slide.

27. The graphic user interface of claim 23 wherein the graphical representations of slides are linked by flow lines that represent the sequence orders of slides.

28. The graphic user interface of claim 24 wherein the boxes depicting groups are connected by a flow line representing the sequence order of groups.

29. The graphic user interface of claim 28 wherein indicators are associated with each flow line.

30. The graphic user interface of claim 29 wherein when a user places an input device over the indicator associated with a flow line the graphical representations of slides and flow lines associated with that indicator are highlighted.

31. The graphic user interface of claim 29 wherein when a user selects the indicator associated with a flow line the sequence order of slides associated with that indicator is selected as the default path.

32. The graphic user interface of claim 29 wherein flow lines that intersect a slide that is actively being presented are depicted in a different color from the other flow lines.

33. The graphic user interface of claim 24 wherein each group of graphical representations of slides is depicted as a thumbnail graphical representation.

34. The graphic user interface of claim 22 further comprising a user interface for measuring the time a presenter spends on each slide in said sequence of slides.

35. The graphic user interface of claim 34 further comprising a user interface for displaying to the presenter an indicator indicating to the presenter an estimate of how much time a slide will take to present.

36. The graphic user interface of claim 34 further comprising a user interface for displaying to the presenter an indicator indicating to the presenter an estimate of how much time the default sequence of slides and each alternative sequence of slides will take to present.

37. A computer-readable medium having computer-executable instructions for creating and controlling an electronic presentation, said computer executable instructions comprising:
creating an electronic presentation, comprising a plurality of slides encompassing presentation data arranged in a plurality of sequences;
displaying the plurality of slides arranged in a plurality of sequences on a first computer screen;
allowing a user to select in real time a subset of the plurality of sequences of slides during presentation on a first computer screen; and
displaying the slides selected on a second display device.
